(19) United States
(12) Patent Application Publication
(10) Pub. No.: US 2014/0069976 A1
(43) Pub. Date: Mar. 13, 2014

(54) WASTE BAG DISPENSER THAT IS DISPOSABLE AND ATTACHABLE TO PLURALITY OF ANIMAL LEASHES

(71) Applicant: John D. Osher, Ft. Lauderdale, FL (US)

(72) Inventor: John D. Osher, Ft. Lauderdale, FL (US)

(73) Assignee: Litey Leash, LLC, Bedford Heights, OH (US)

(21) Appl. No.: 14/021,415

(22) Filed: Sep. 9, 2013

Related U.S. Application Data
(60) Provisional application No. 61/698,063, filed on Sep. 7, 2012.

(51) Int. Cl. A01K 27/00

(52) U.S. Cl. CPC A01K 27/008
USPC 224/576; 221/283; 221/26

(57) ABSTRACT

A waste bag dispenser for use with an animal leash has a dispenser body having a first end and a second end, and a first side and a second side, a removably secured flap covering an opening formed on the first side and adjacent the first end of the dispenser body, at least one fastener is secured to the second side of the dispenser body, and a plurality of waste collecting bags are housed within the dispenser body which are removed from the body through the opening.

### CLAIM OF PRIORITY

This application claims priority from Provisional Application Ser. No. 61/698,063, filed on Sep. 7, 2012, which is hereby incorporated by reference in its entirety.

### BACKGROUND OF THE DISCLOSURE

The disclosure relates to a waste bag dispenser. More particularly, it relates to a waste bag dispenser for selective or removable attachment to an animal leash for holding a plurality of waste bags which when the plurality of bags are used or is consumed the dispenser is itself is disposable.

There is a need for improved devices relating to collecting animal litter and waste. There currently exists a wide range of reusable dispensers that house and distribute animal waste bags. Many of these re-usable dispensers are attachable to animal leashes, generally by attaching in some fashion to the handle of the animal leash. A disadvantage of this arrangement is it often restricts the movement of the hand of the operator or otherwise creates an encumbrance on the leash and its operation. In addition, another disadvantage is once the last waste bag housed in a reusable dispenser has been spent, it is often unclear to the operator that it is empty, which can cause the operator to incorrectly assume that the dispenser contains waste bags when, in fact, it is empty.

Thus, there exists a need for an animal waste-bag dispenser that is itself disposable so that it may be removed and disposed of so as to remove any confusion as to whether it contains bags or is empty and is selectively attachable to a plurality of animal leashes. The waste bag dispenser is disposable so that when all the bags in the dispenser have been consumed, the dispenser can be thrown away and a new dispenser attached to the leash. The dispenser is attached to the leash, as opposed to the handle and is configured in a lightweight and easy to use assembly to minimally depart from the pull of a normal leash function to a user. Such a dispenser assembly easily attaches to or is separated from the leash.

### SUMMARY OF THE DISCLOSURE

The disclosure relates to a waste bag dispenser. More particularly, it relates to a waste bag dispenser for selective or removable attachment to an animal leash for holding a plurality of waste bags which when the plurality of bags are used or is consumed the dispenser itself is disposable.

In accordance with one aspect of the disclosure, a disposable dispenser of waste bags is attached to an animal leash with a handle. The dispenser itself can be made of vinyl, plastic, or any suitable lightweight material.

In accordance with another aspect of the disclosure, the disposable dispenser can hold a plurality of waste bags which can be sequentially pulled from the dispenser for collecting animal waste or litter, or other litter or anything else that the operator would like to place into the bag.

In accordance with another aspect of the disclosure, the dispenser has an aperture or opening that closely receives an end of a bag. A slight force must be applied to pull the bag from the dispenser. As the complete bag is pulled from the dispenser, its terminal end is attached to the next bag via a perforated line so that the bag intended for use must be torn from a stream of bags within the dispenser after exposing an end of the next bag to be used.

In accordance with another aspect of the disclosure, a waste bag dispenser for use with an animal leash includes a dispenser body having a first end and a second end, and a first side and a second side, a removably secured flap covering an opening formed on the first side and adjacent the first end of the dispenser body, at least one fastener is secured to the second side of the dispenser body, and a plurality of waste collecting bags is housed within the dispenser body which are removed from the body through the opening.

Another aspect of the disclosure is a waste bag dispenser which is disposable.

Another aspect of the disclosure is a disposable waste bag dispenser containing multiple waste bags which is selectively or removably attached via an adhesive strip to an animal leash.

Another aspect of the disclosure is a disposable waste bag dispenser or holster containing multiple waste bags which is selectively and removably attached to a leash via a tie strap and is removed entirely after the bags are used and is replaced with a new dispenser or holster.

Another aspect of the disclosure is a disposable holster that attaches to a leash via tie straps and a disposable waste bag dispenser or pack containing multiple bags which is removably secured to the holster such as by adhesive.

Still another aspect of the disclosure is a pull tab which is pulled away from the dispenser to reveal an opening through which bags are selectively dispensed.

Another aspect of the disclosure is a pull tab which is resealable.

Still another aspect of the disclosure is a waste bag dispenser that is lightweight and easy to use.

Yet another aspect of the disclosure is a waste bag dispenser that is attached to a leash instead of a handle.

In accordance with still another aspect of the disclosure, a disposable dispenser of animal waste bags including a plurality of waste collecting bags has a housing having an opening for selective and sequential individual bag removal by an operator using one hand, wherein the dispensing assembly includes fasteners for selective attachment to a length of the animal leash.

Other aspects of the disclosure will be apparent upon a reading and understanding of the following detailed description.

### BRIEF DESCRIPTION OF THE DRAWINGS

FIG. 1 is a side elevation view of a waste bag dispenser on an animal leash in accordance with a first embodiment of the disclosure;

FIG. 2 shows a side elevational view of the dispenser of FIG. 1 showing a bag being removed from the dispenser;

FIG. 3 is another side elevational view of the dispenser showing a bag being removed from the dispenser;

FIG. 4 is a side elevational view of the dispenser showing a release tape attached thereon;

FIG. 5 is an enlarged view of an end of the dispenser adjacent an alternate leash handle in accordance with a second embodiment of the disclosure;

FIG. 6 is a side elevational view of the dispenser attached to an animal leash;

FIG. 7 shows a plurality of dispensers in various ornamental configurations;

FIG. 8 is a side elevational view of a waste bag dispenser in accordance with another aspect of the disclosure;

FIG. 9 is a side elevational view of an opposite side of the waste bag dispenser of FIG. 8;

FIG. 10 is a side elevational view of the waste bag dispenser of FIG. 8 showing the dispenser being attached to a leash;

FIG. 11 is a side elevational view of the waste bag dispenser of FIG. 8 showing the pull tab being pulled to release a waste bag from the dispenser.

FIG. 12 is a perspective view of a waste bag dispenser in accordance with another aspect of the disclosure

FIG. 13 is a top plan view of the waste bag dispenser of FIG. 12; and

FIG. 14 is a perspective view of a holster in accordance with another aspect of the disclosure.

### DETAILED DESCRIPTION OF THE DISCLOSURE

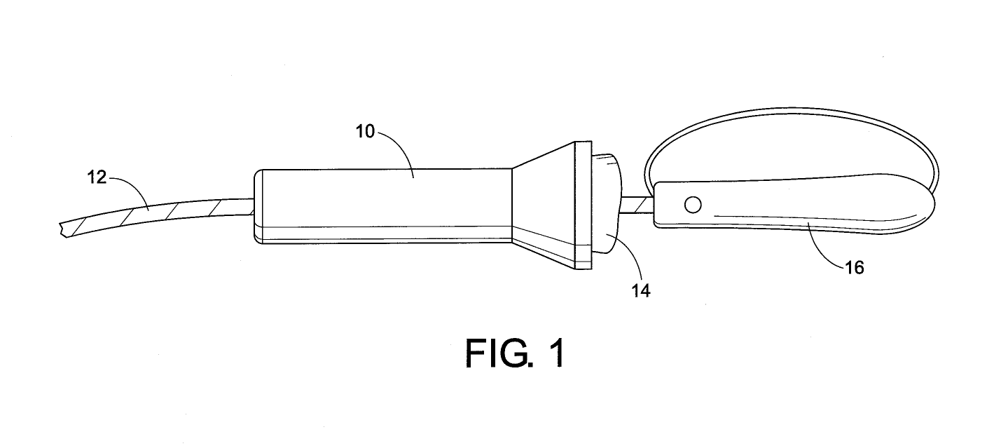

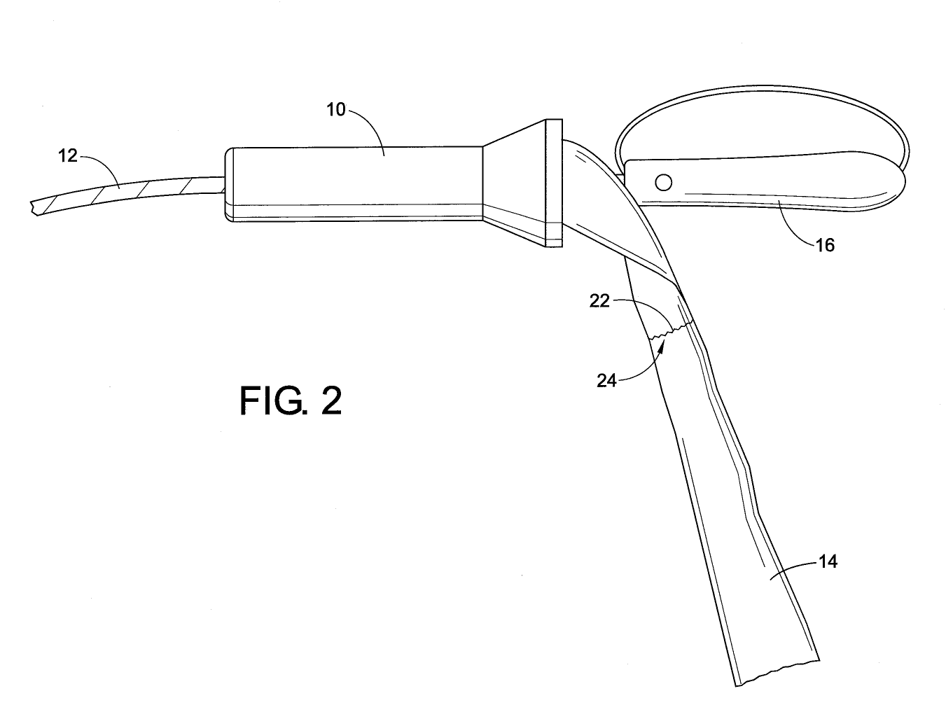

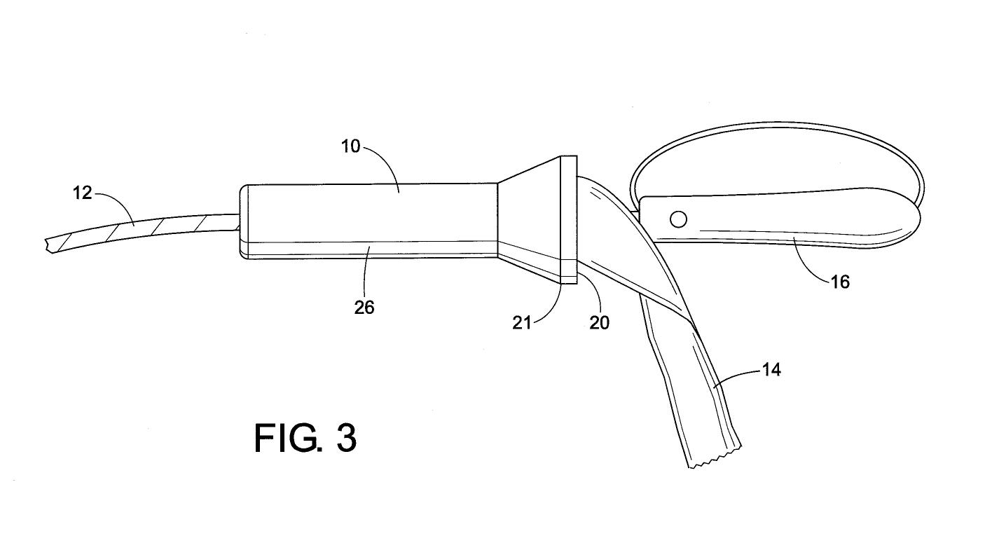

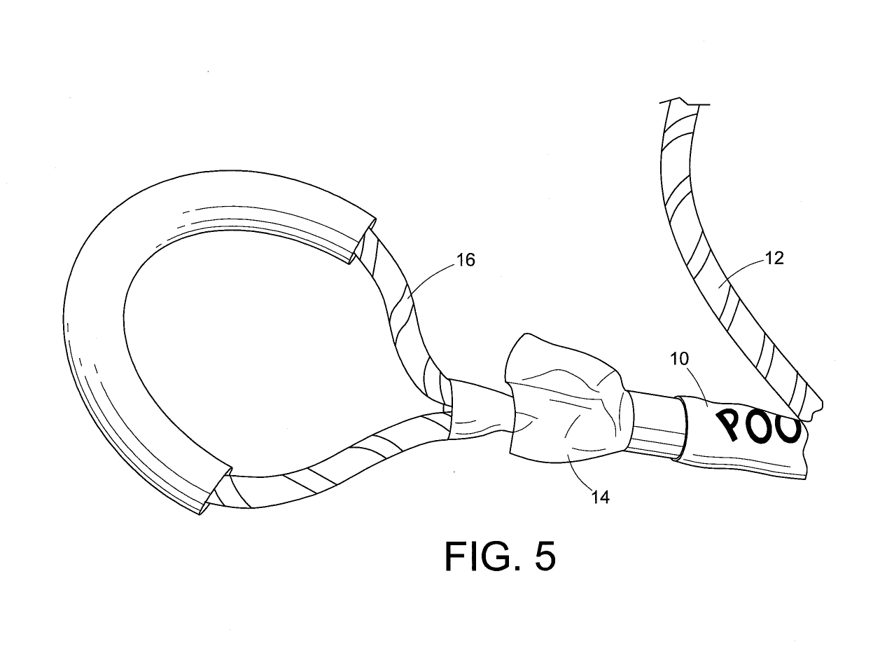

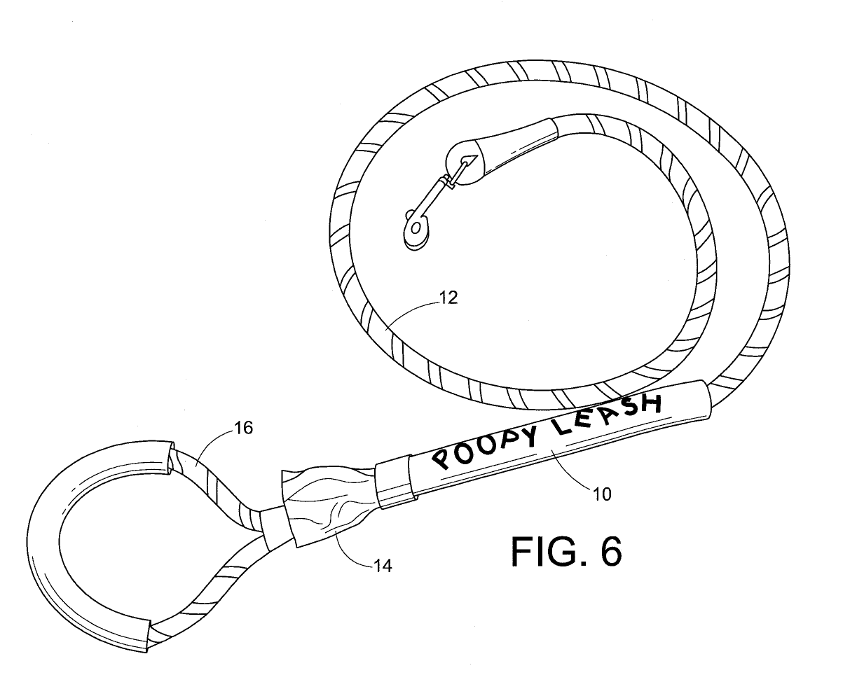

With reference now to FIGS. 1-3, a disposable dispenser 10 of waste bags in accordance with one aspect of the disclosure is shown attached to an animal leash 12 with a handle 16. FIGS. 5 and 6 show the dispenser 10 attached to a leash with an alternate handle 16. The dispenser itself can be made of vinyl, plastic, or any suitable lightweight material. The disposable dispenser preferably holds a plurality of waste bags 14 which can be sequentially pulled from the dispenser 10 for collecting animal waste or litter, or other litter or anything else that the operator would like to place into the bag 14. Attaching selectively to a portion of the leash, the dispenser leaves a leash handle 16 completely unencumbered.

The waste bags are conventional plastic refuse bags 14, similar to household garbage bags, assigned for sequential release from the dispenser 10. Only a few bags are initially contained within the dispenser so that the weight of a full dispenser 10 will not noticeably impact normal leash operation. In the embodiment shown, the dispenser has an aperture or opening 20 at a first end 21 that closely receives an end of a bag 14. A slight force must be applied to pull the bag 14 from the dispenser. As the complete bag is pulled from the dispenser, its terminal end 22 is attached to the next bag via a perforated line 24 so that the bag intended for use must be torn from a stream of bags within dispenser housing 26 after exposing an end of the next bag to be used. Such a method of bag dispensing is well known in the art.

When the dispenser 10 is emptied of all bags therein, it is preferably disposed, not refilled, and a new bag assembly can be easily attached to the leash. A wide variety of fastening devices can be selectively employed for ready attachment and release of the dispenser 10 from the leash. For example, tapes, adhesive strips, fastening strips, clips, zippers, buttons, Velcro® straps, or the like are typical embodiments of such fastening devices.

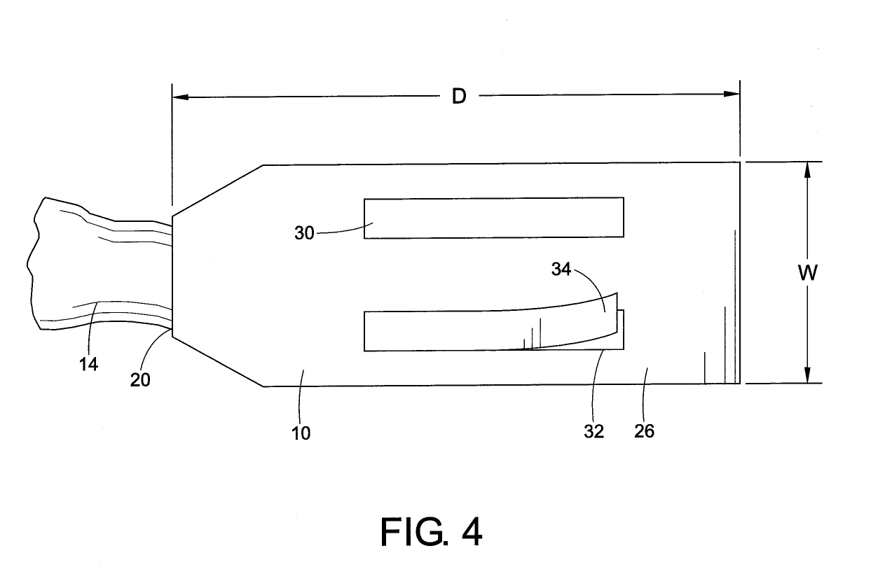

A preferred way of securing the dispenser to a leash is shown in FIG. 4. One or more double sided adhesive or tape strips 30 are secured to one side 32 of the dispenser. Release paper 34 is removed from the tape or adhesive strip, then the dispenser is wrapped around or secured to the leash by the strips. By wrapping the dispenser around the leash, the dispenser is secured to the leash in a manner which improves upon simply attaching the dispenser to the leash handle.

The housing 26 of the dispenser 10 is intended to provide a waterproof container for the bags therein, but for the opening for pulling the bags from the dispenser. In the embodiment shown, an elongated flexible housing is shown, but the embodiments are intended to encompass other shapes or configurations so long as the desired purpose of minimal effect on leash operation is achieved.

Referring to FIG. 4, the dispenser 10 is preferably a dimension D of about six or seven inches long and has a width W of about 1.5 or 2 inches wide. However, other dimensions are also contemplated by the disclosure. The dispenser is configured and designed to be easily attached and removed from any type of leash, with any type of handle.

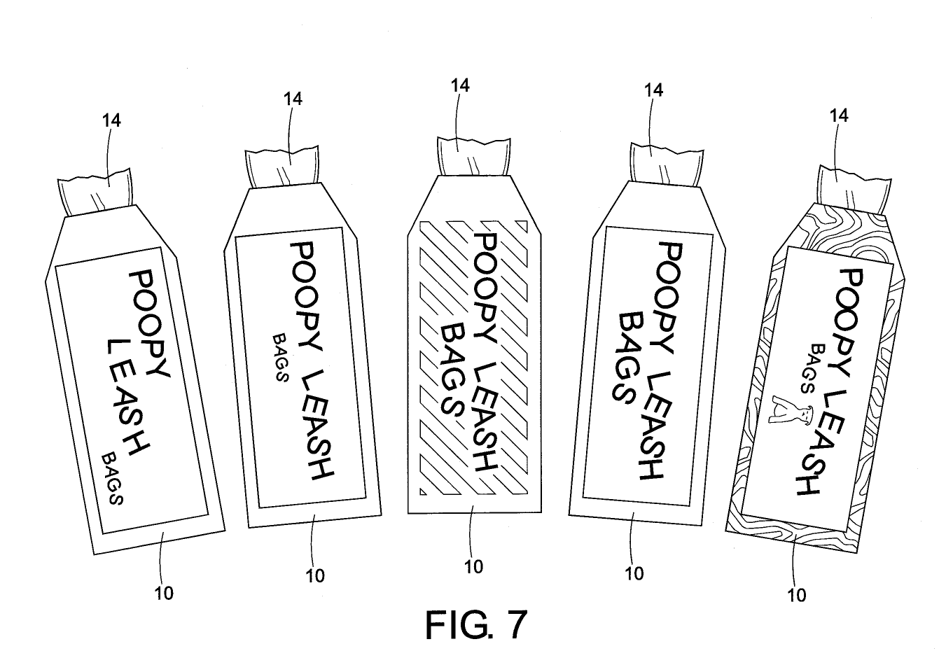

The dispenser can easily accommodate about thirty or so bags, but other numbers of bags are contemplated by the disclosure. FIG. 7 illustrates various configurations of the dispenser 10 with different ornamental appearances and colors to complement the style of leash to which the dispenser is attached.

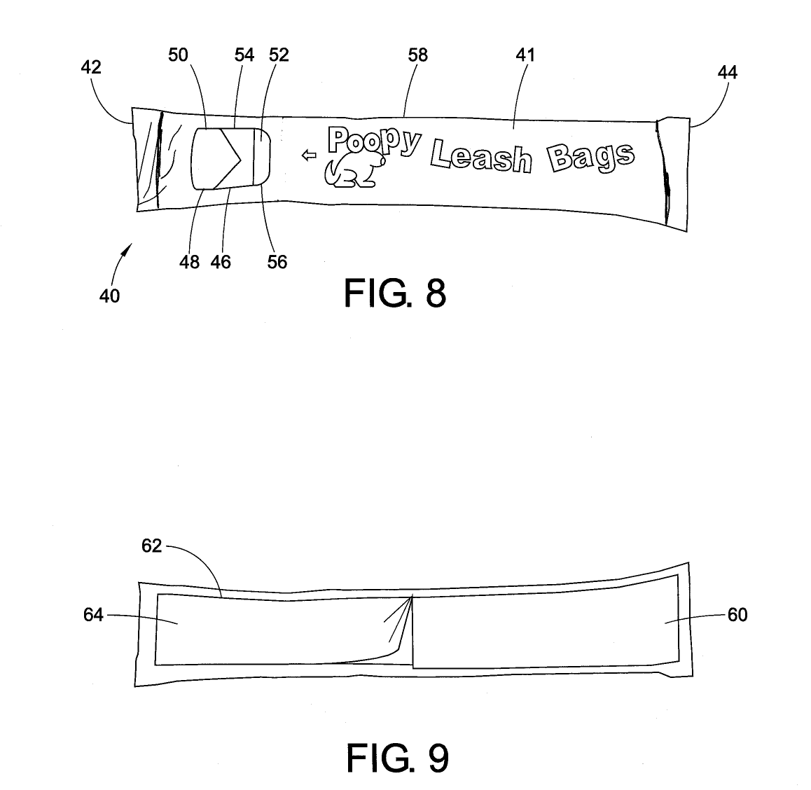

With reference now to FIGS. 8-11, a disposable dispenser or holster 40 of waste bags in accordance with another aspect of the disclosure is shown. The dispenser itself can be made of vinyl, plastic, or any suitable lightweight material. Dispenser 40 is shown as a thin plastic film container or housing 41 which is transparent and sealed at opposite ends 42, 44. The disposable dispenser preferably holds a plurality of waste bags 46 which can be sequentially pulled out individually from the dispenser 40 for collecting animal waste or litter, or other litter or anything else that the operator would like to place into the bag 46. By attaching selectively to a portion of the leash, the dispenser leaves a leash handle completely unencumbered.

The waste bags 46 are conventional plastic refuse bags, similar to household garbage bags, assigned for sequential release from the dispenser 10. The bags and the dispenser are very lightweight so as to not noticeably impact normal leash operations. In the embodiment shown, the dispenser has an aperture or opening 48 that closely receives an end of a bag 46. A slight force must be applied to pull the bag 46 from the dispenser. The operator can pull each bag out individually using one hand, thus freeing the other hand to hold the leash. The bag is folded over several times and is neatly extracted from the dispenser. A plurality of bags, such as about twenty to thirty, are folded and stacked within the dispenser such that after one bag is pulled out of the dispenser another bag is immediately positioned next to the opening 48 to be pulled out of the dispenser. Referring to FIG. 11, adjacent the first end 42 of the dispenser is a pull flap 50, which has a pull tab 52 and a perforated or otherwise selectively removable portion 54 and an adhesive portion 56 which adheres or secures the flap to the dispenser body.

When the pull tab 52 is pulled by the user, the flap separates from the dispenser body and exposes opening 48 and bag 46. The pull flap 50 is located on a first side 58 of the dispenser.

When the dispenser 40 is emptied of all bags therein, it is preferably disposed, not refilled, and a new bag dispenser assembly can be easily attached to the leash. A wide variety of fastening devices can be selectively employed for ready attachment and release of the dispenser 40 from the leash. For example, tapes, adhesive strips, fastening strips, clips, zippers, buttons, Velcro® straps, or the like are typical embodiments of such fastening devices.

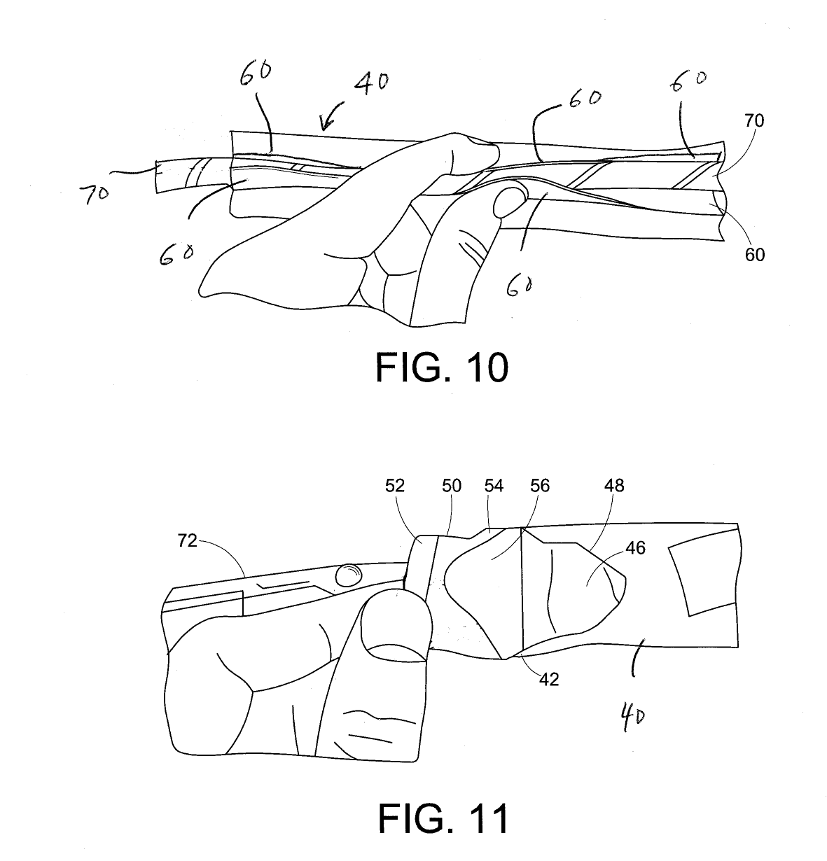

One preferred way of securing the dispenser to a leash 70 is shown in FIGS. 9 and 10. One or more double sided adhesive or tape strips 60 are secured to a second side 62 of the dispenser. Release paper or cover 64 is pulled from and removed from the tape or adhesive strip to expose the adhesive strip, then the dispenser is wrapped around or secured to the leash by the strips. By wrapping the dispenser around the leash, the dispenser is better secured to the leash than other existing methods. Referring to FIG. 10, the adhesive strip 60 is pressed onto the leash and can wrap at least partially around the circumference of the leash 70 to aid in securing the dispenser to the leash.

Body or housing 41 of the dispenser 40 is intended to provide a waterproof container for the bags therein, except for the opening for pulling the bags from the dispenser. In the embodiment shown, an elongated flexible housing is shown, but the embodiments are intended to encompass other shapes or configurations so long as the desired purpose of minimal effect on leash operation is achieved.

The dispenser 40 has a length of about six or seven inches and has a width of about 1.5 or 2 inches wide. However, other dimensions are also contemplated by the disclosure. The dispenser is configured and designed to be easily attached and removed from any type of leash, with any type of handle.

Referring now to FIG. 11, the bags are secured within the dispenser in such a manner that when one of the bags is removed the next bag is brought into immediate alignment with the opening 48 for removal of bags. Once the bag is removed, the flap is resealed to close the bag opening.

To use the waste bag dispenser, the paper backings 64 that cover the adhesive strip 60 are removed so that the adhesive strip is exposed.

The dispenser is then oriented to the leash 70 so that the end 42 with the pull flap 50 is oriented toward an outer end of the leash near handle 72 and the user (i.e., the end away from the animal).

The adhesive strip 60 is then pressed and affixed onto the animal leash. Referring to FIG. 10, the strip may be wrapped around the leash to firmly secure the dispenser onto the leash.

The resealable flap 50 is then pulled at the tab 52 and one of the bags is completely pulled out of the dispenser and removed. The next bag is then positioned adjacent to the opening to separate it from the dispenser. Then the flap is resealed to contain and protect the remaining bags.

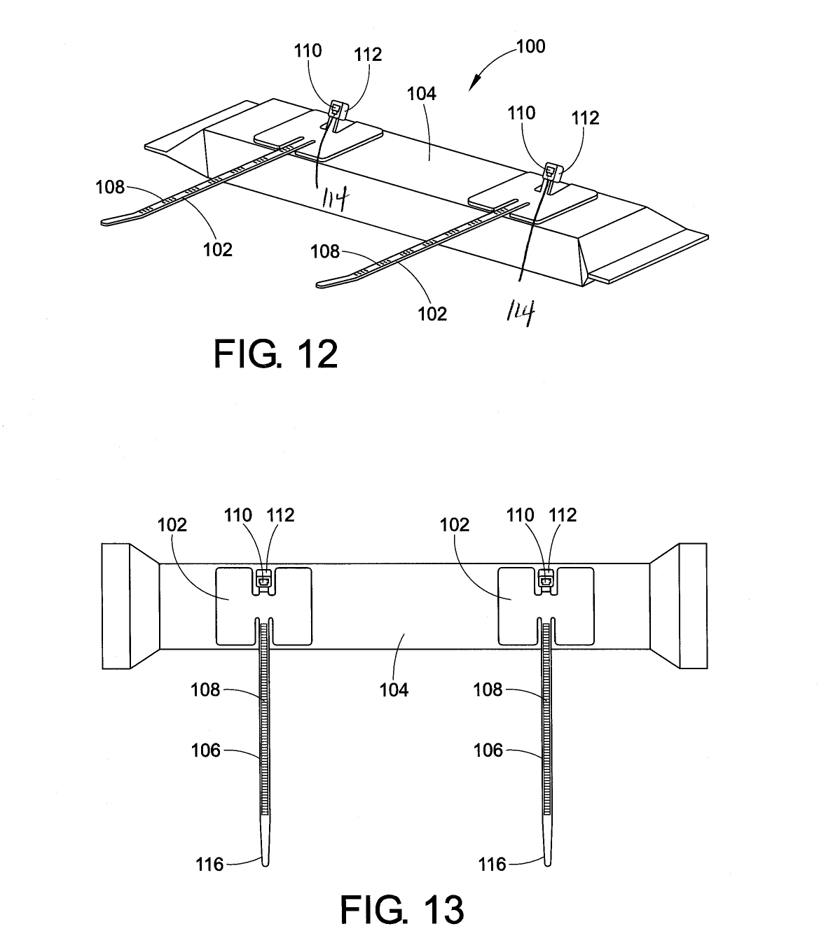

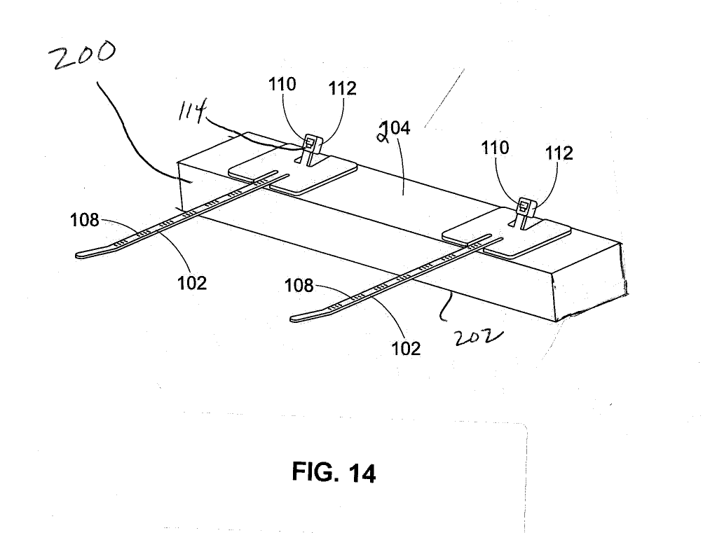

Referring now to FIGS. 12 and 13, another way of securing the dispenser to the leash in accordance with another aspect of the disclosure is shown. Waste bag dispenser 100 is much the same as the dispenser 40 discussed relative to FIGS. 8-11. Instead of adhesive strips, however, plastic tie straps or zip ties 102 are secured to a side 104 of the dispenser opposite the dispensing side which has an opening for dispensing bags much like opening 48 of dispenser 40. The straps themselves have an elongated portion 106 having a plurality of locking teeth 108 thereon which is pulled through opening 110 of portion 112. The teeth engage a tab 114 within opening 110 to lock the tie strap at a desired position. The strap is pulled or looped around the leash and then end 116 is inserted into opening 110 and is pulled to a desired position and is locked into position via teeth 108 within opening 110.

When the last bag is used, the dispenser is simply pulled off of the leash and is discarded. A new dispenser full of waste bags with another tie strap is then attached to the animal leash.

Alternatively, a separate holster 200 may be attached to a leash using one or more tie straps 102 which are attached to a side 204 of the holster. A dispenser or pack 40 containing individual waste bags (such as about twenty-five bags) can then be removably secured to the holster via adhesive strips on opposite side 202 such as illustrated and explained in FIGS. 8-11. When the dispenser 40 is depleted of all the bags, the dispenser is removed from the holster 200 and disposed and a new dispenser is attached to the holster. The holster is ultimately disposable as well.

It will be appreciated that variants of the above-disclosed and other features and functions, or alternatives thereof, may be combined into many other different systems or applications. Various presently unforeseen or unanticipated alternatives, modifications, variations or improvements therein may be subsequently made by those skilled in the art which are also intended to be encompassed by the following claims.

1. A waste bag dispenser for use with an animal leash, comprising:
a dispenser body having a first end and a second end, and a first side and a second side, a removably secured flap covering an opening formed on said first side and adjacent said first end of said dispenser body;
at least one fastener secured to said second side of said dispenser body; and
a plurality of waste collecting bags housed within said dispenser body which are selectively and sequentially removed from said body through said opening.

2. The waste bag dispenser of claim 1, wherein said dispenser body is made of plastic.

3. The waste bag dispenser of claim 1, wherein said waste collecting bags are made of plastic.

4. The waste bag dispenser of claim 1, wherein said waste collecting bags are folded and stacked within said dispenser body.

5. The waste bag dispenser of claim 1, wherein said fastener comprises at least one adhesive strip.

6. The waste bag dispenser of claim 1, wherein said fastener comprises at least one tie strap which loops around said leash.

7. The waste bag dispenser of claim 6, wherein said tie strap comprises a first elongated portion with teeth which is pulled through an opening in a second position.

8. The waste bag dispenser of claim 1, wherein said flap is removably secured to said dispenser body via adhesive and further comprises a tab.

9. The waste bag dispenser of claim 1, wherein said first end and second end of said dispenser body are sealed.

10. The waste bag dispenser of claim 5, wherein said adhesive strip is wrapped around said leash for securing said dispenser to said leash.

11. The waste bag dispenser of claim 5, wherein said adhesive strip is secured to a holster secured to said leash via at least one tie strap.

12. The waste bag dispenser of claim 5, wherein said adhesive strip comprises a cover that is peeled off to expose said adhesive strip.

13. The waste bag dispenser of claim 8, wherein when said tab is pulled, said flap is pulled away from said dispenser and said exposes said opening for removal of one of said plurality of bags.

14. The waste bag dispenser of claim 13, wherein as one of said bags is removed from said dispenser, an adjacent one of said bags is then positioned adjacent said opening.

15. A disposable dispenser of animal waste bags selectively attached to a leash, comprises a plurality of waste collecting bags within a housing, said housing has an opening for selective and sequential bag delivery to an operator of the leash, wherein said dispensing assembly includes fasteners for selectively attaching to said leash.

16. The disposable dispenser of claim 15, wherein said dispenser is wrapped around said leash and is secured to said leash by said fasteners.

17. The disposable dispenser of claim 16, wherein said fasteners comprise at least one adhesive strip.

18. The disposable dispenser of claim 16, wherein said dispenser opening is formed at an end of said dispenser.

19. The disposable dispenser of claim 15, wherein each of said plurality of bags are connected together at opposite ends via perforations.
